(19) United States
(12) Patent Application Publication
(10) Pub. No.: US 2014/0366329 A1
(43) Pub. Date: Dec. 18, 2014

(54) Trigger Happy Comfort Grip

(71) Applicant: Loren Pernell Jenkins, Elk Grove, CA (US)

(72) Inventor: Loren Pernell Jenkins, Elk Grove, CA (US)

(21) Appl. No.: 14/200,025

(22) Filed: Mar. 7, 2014

Related U.S. Application Data
(60) Provisional application No. 61/851,484, filed on Mar. 8, 2013.

(51) Int. Cl. A01K 87/08; B25G 1/10

(52) U.S. Cl. CPC A01K 87/08; B25G 1/10
USPC 16/421

(57) ABSTRACT

A grip for all casting type fishing rods is disclosed which has a resiliently flexible rubber hollow tubular shape (interior) with the ability to employ a variety of exterior surface textures, including knurls, ribs, waves, etc. The grip is shaped so that it provides a uniform fit over the hard plastic triggers of casting rods, the opening, regardless of its shape provides a suction-type grip onto the trigger once the grip is placed onto the trigger. The rubber conforms to any shape of trigger and compresses uniformly to provide a custom fit. The radial thickness of the grip is smaller in comparison to the grip, yet, generally mirrors the overall shape of the exterior of the grip with the exception of the chosen external surface texture which can vary. The grip itself, during use compresses and conforms to the individual user's finger and hands.

### FIELD OF THE INVENTION

This invention relates to ergonomic improvements that afford the user a comfortable, non-impeding grip mechanism to relieve pain and discomfort and reduce slippage that can be experienced from the hand and fingers applying constant pressure on the hard plastic triggers.

### BACKGROUND OF THE INVENTION

Casting type fishing rods are fashioned with a hard plastic trigger that helps the user grip the rod and provide leverage during all related fishing/angling activities which include casting, retrieving and fighting fish. During all of these activities an amount of force is required to maintain the grip on the fishing rod. The hands and fingers work in unison to provide these activities whereby an amount of strain is place upon the hands and fingers due to the hard plastic material of the trigger contacting the flesh and skin of the user.

In order to provide comfort for the hands and fingers, particularly in between the fingers where the hard plastic triggers actually contact the skin, the soft ergonomic grip is employed. This grip provides a soft pleasurable feeling for the user which allows the user to complete all of the functions and activities of angling, less the pain that can be associated to grasping the hard plastic trigger.

In addition, the grip also provides a mechanism to improve the grasp and reduce slippage by providing a tacky surface to the trigger.

### SUMMARY OF THE INVENTION

The grip for a casting type fishing rod trigger of this invention has a resilient soft rubber receptacle. The inner wall of the grip is smaller in comparison to the outer wall, but mirrors it's general shape although the external features and surface texture can vary. The soft, resilient quality of the grip allows the grip to “receive” and conform to the trigger of the casting rod.

It is an object of the present invention to provide comfort to the user who is grasping the trigger.

It is an object of the present invention to provide a grip that reduces hand/finger slippage during angling.

It is an object of the present invention to provide a trigger grip that can accommodate a variety of trigger shapes and sizes.

It is a further object of the present invention to reduce pain in the hands and fingers by providing a soft cushion over the hard plastic trigger of the casting rod.

### BRIEF DESCRIPTION OF THE DRAWINGS

FIG. 1 shows a front view of a conventional prior art cast type fishing rod.

FIG. 2 shows a front view of the trigger grip to be inserted onto the trigger of the fishing rod.

FIG. 3 shows a front view of the trigger grip installed and firmly in place.

FIG. 4 shows an isometric view of the trigger grip.

FIG. 5 shows a front view of the trigger grip in use and installed on the trigger.

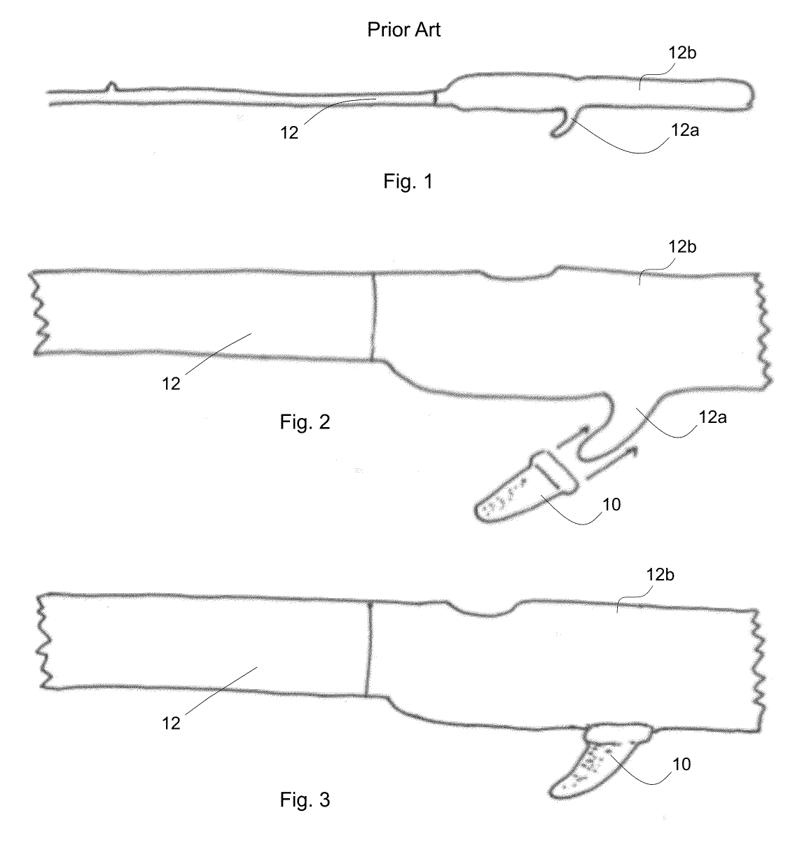

### DESCRIPTION OF THE PREFERRED EMBODIMENT

Referring more particularly to the images, wherein like numbers refer to similar parts, FIGS. 2-4 show a Trigger Happy Comfort Grip 10 for casting rods 12. The Trigger Happy Comfort Grip is formed of a moldable, resilient rubber materiel, yet can vary in their basic shape and construction.

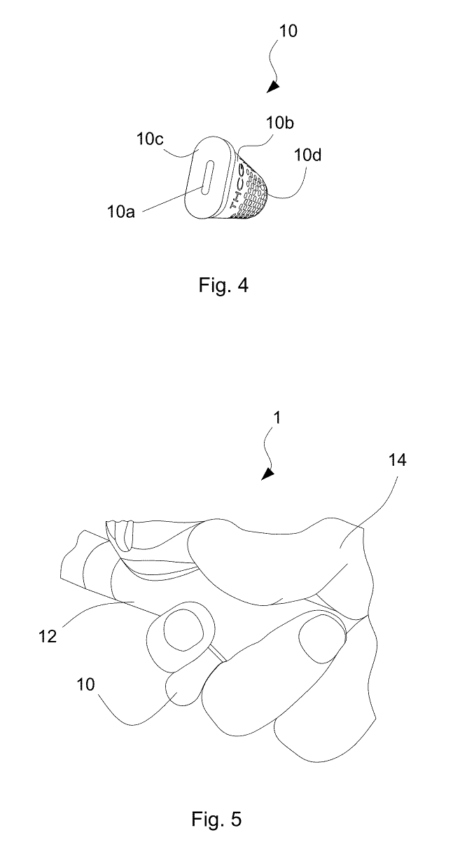

As shown in FIG. 4, the body 10b of the grip 10 can have a variety of shape and construction, but will typically be between 1⅛″ and 1¼″ in length.

As shown in FIG. 4, the grip 10 includes a tubular-shaped main inner wall 10a and a consistently shaped exterior wall 10b. The main inner wall 10a includes an opening of the grip 10. The grip 10 further includes a flange 10c and the exterior wall 10b includes external surfaces 10d. The external surfaces 10d can have a variety of possible external surfaces.

An effective grip of the flexible material will tend to apply a compressive force to the grip 10, serving to keep the grip in place when grasped between the angler's fingers as shown in FIG. 5.

The Trigger Happy Comfort Grip 10 has resilient cushioning effects and conform to the size, shape an any features or effects such as jewelry, etc. that may be on the fingers and provides a spongy sensation and comfort without the loss of sensitivity of the rod.

As seen in FIG. 3, the removable grip 10 extends about an exterior periphery of the trigger 12a. The opening of the grip receives and conforms to the shape of the trigger 12a. The main inner wall 10a elastically grips the trigger 12a to secure the grip 10 to the trigger 12a. The grip 10 employs a suction effect on the trigger 12a. The flexible material of the grip 10 itself resiliently deforms when a user grasps the trigger between their fingers.

It is understood that the invention is not confined to the particular construction and arrangement of parts herein illustrated and described, but embraces all such modified forms thereof as come within the scope as claimed.

1. (canceled)

2. A fishing rod in combination with a removable grip, the fishing rod including a trigger projecting from the body;
wherein the grip extends from an exterior periphery of the trigger; wherein the grip includes an opening including a tubular-shaped inner wall; and,
wherein the grip further includes an exterior wall.

3. The combination as claimed in claim 2, wherein the tubular shaped inner wall is resiliently deformable to conform to the shape of the trigger and elastically grips the trigger to secure the grip to the trigger.

4. The combination as claimed in claim 3, wherein the external wall comprises a resiliently flexible material to allow a user to grasp the trigger between two fingers while the grip conforms to the fingers.

5. The combination as claimed in claim 1, wherein the grip further includes external surfaces.

6. The combination as claimed in claim 5, wherein the grip further includes a peripheral flange extending perpendicular to a longitudinal axis of the opening.

7. A removable grip including an opening including a tubular-shaped inner wall; and,
wherein the grip further includes an exterior wall.

8. The removable grip as claimed in claim 7, wherein the tubular shaped inner wall is resiliently deformable to conform to a trigger of a fishing rod.

9. The removable grip as claimed in claim 8, wherein the external wall comprises a resiliently flexible material to allow a user to grasp the trigger between two fingers while the grip conforms to the fingers.

10. The combination as claimed in claim 7, wherein the grip further includes external surfaces.

11. The combination as claimed in claim 10, wherein the grip further includes a peripheral flange extending perpendicular to a longitudinal axis of the opening.
